(19) United States
(12) Patent Application Publication
(10) Pub. No.: US 2017/0349229 A1
(43) Pub. Date: Dec. 7, 2017

(54) BICYCLE BEVERAGE CUP HOLDER

(71) Applicant: Delta Cycle Corporation, Randolph, MA (US)

(72) Inventors: Errol Drew, Los Gatos, CA (US); Natalie Mukhtar, San Jose, CA (US)

(73) Assignee: Delta Cycle Corporation

(21) Appl. No.: 15/421,786

(22) Filed: Feb. 1, 2017

Related U.S. Application Data
(60) Provisional application No. 62/344,022, filed on Jun. 1, 2016.

(51) Int. Cl. B62J 11/00

(52) U.S. Cl. CPC B62J 11/00

(57) ABSTRACT

A bicycle beverage cup holder and method features spaced flexible concave arms each having a distal end. There is a gap between the distal ends of the arms. A bracket secures the spaced concave arms to a bicycle handlebar. A stretchable band is operatively disposed across the gap to accommodate different size beverage cups and to secure them in place.

### RELATED APPLICATIONS

This application claims benefit of and priority to U.S. Provisional Application Ser. No. 62/344,022 filed Jun. 1, 2016, under 35 U.S.C. §§119, 120, 363, 365, and 37 C.F.R. §1.55 and §1.78, which is incorporated herein by this reference.

### FIELD OF THE INVENTION

This invention relates to bicycle cup holders.

### BACKGROUND OF THE INVENTION

A popular activity includes bicycling to a coffee shop or any beverage purveyor and then transporting a purchased beverage via the bicycle.

Traditional bike bottle cages are unsuitable for transporting coffee cups and similar beverages. Attempts have been made to engineer more approximate coffee cup holders for bicycles. See, for example, U.S. Published Application No. 2009/0095765 and U.S. Pat. No. 5,752,687 both incorporated herein by this reference.

### BRIEF SUMMARY OF THE INVENTION

Some prior art bicycle coffee cup holders are complex and/or expensive. Featured in this invention is a bicycle coffee cup holder with spaced concave arms biased about a coffee cup via a stretchable band that itself includes an inside friction surface for securely holding different size coffee cups.

In some aspects, a bicycle beverage cup holder comprises spaced flexible concave arms each having a distal end with a gap between the distal ends of the arms. A bracket secures the spaced concave arms to a bicycle handlebar. A stretchable band is operatively disposed across the gap to bias the arms about a beverage cup and to accommodate different size (e.g., diameter) beverage cups.

In one design, one said arm distal end includes a hook and the stretchable band includes an end with a channel receiving said hook therein. The hook may extend outwardly from said arm distal end and includes a rearwardly extending post. Preferably, both said arm distal ends each include a hook and the stretchable band includes opposing ends each with a channel receiving a said hook therein. The band may include a friction surface and may be made of rubber. The spaced arms may each have top and bottom rings.

Also featured is a method of transporting a beverage cup on a bicycle. The beverage cup holder includes spaced flexible concave arms clamped to a bicycle handlebar. A beverage cup is inserted between the arms spreading apart the arms. A band is stretched from the distal end of one arm about the beverage cup and releasably secured to the distal end of the other arm biasing the arms about the beverage cups.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is schematic three dimensional view of a prior art bicycle bottle cage;

FIG. 2 is a schematic view of the Assignee's prior coffee cup holder;

FIG. 3 is a schematic three dimensional view of an example of a new beverage cup holder in accordance with the invention;

FIG. 4 is a schematic three dimensional front view of the holder of FIG. 3;

FIGS. 5A-5C are schematic views of the inside of the stretchable band shown in FIGS. 3 and 4;

FIG. 6 is another schematic view of an example of a bicycle beverage cup holder;

FIG. 7 is a schematic view of the cup holder of FIGS. 3-6 in place on a bicycle and holding a cup; and

FIG. 8 is a top view of the cup holder showing how it expands to grip different size cups.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

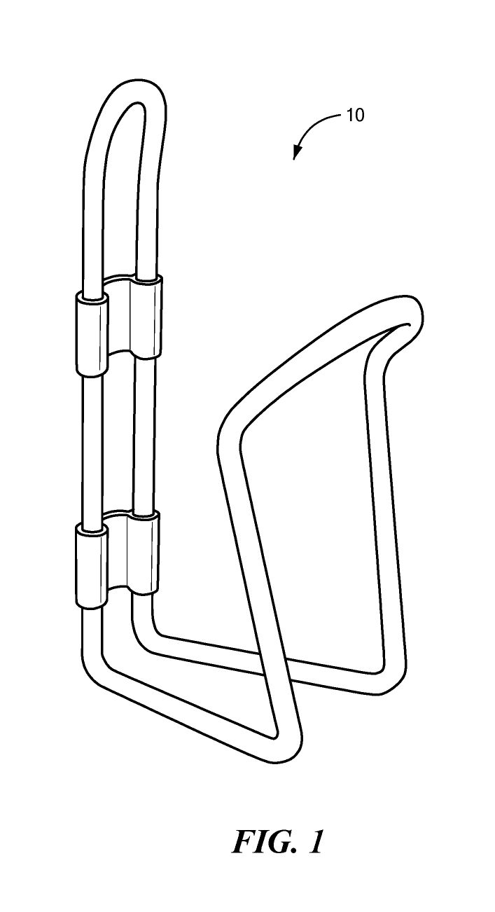

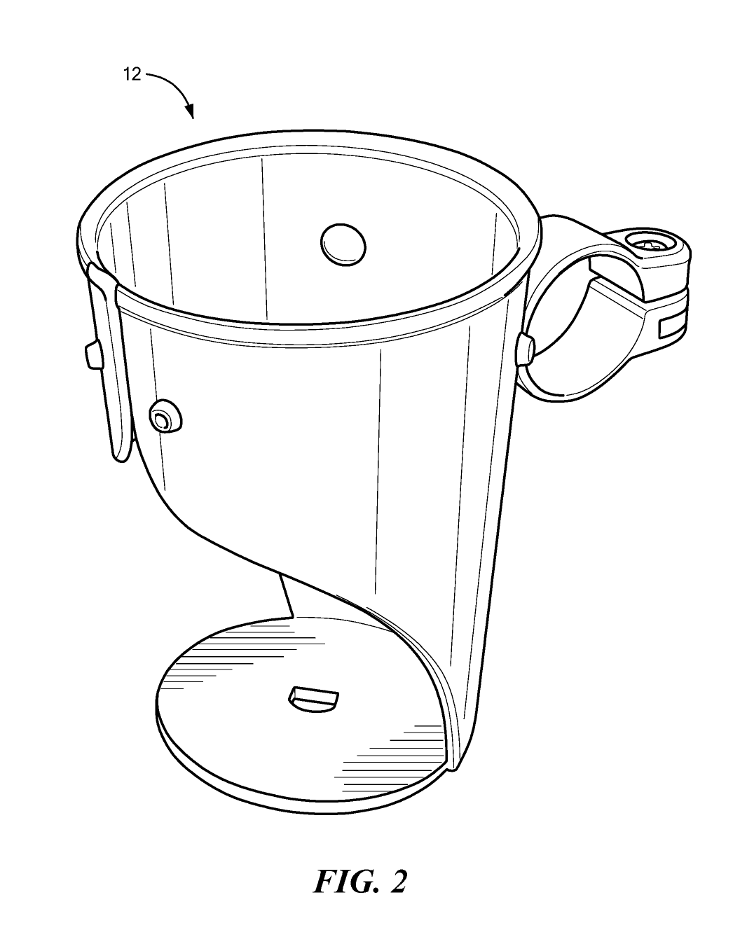

FIG. 1 shows an example of a bicycle water bottle holder 10 largely unsuitable for transporting a coffee cup. FIG. 2 shows an example of the Applicant's prior beverage cup holder 12.

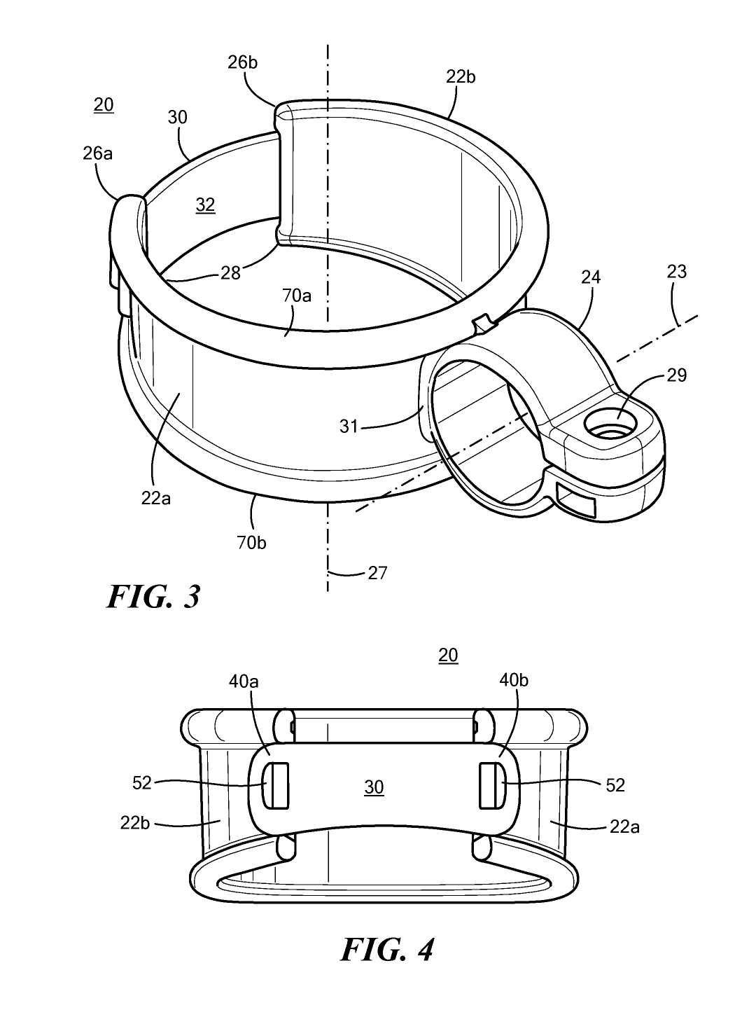

FIGS. 3-4 show an example of an improved new design where holder 20 includes flexible clamping ring 21 (e.g., 2-3″ in diameter). Clamping ring 21 includes connected spaced concave flexible plastic arms 22a and 22b which spread apart and close together to accept different diameter beverage containers. Rearwardly extending split ring bracket 24 attached to rearward wall 31 of clamp ring 21 secures arms 22a, 22b at their rearward junction to a bicycle handle bar section via a fastener received through orifice 29. Each arm has a distal end 26a, 26b and there is a gap 28 (e.g., 1-2″) between the distal ends of the arms. Stretchable band 30 is operatively disposed across gap 28 and is attached to the distal ends of the arms.

In the preferred example shown, band 30 biases arms 22a, 22b about different size beverage cups as band 30 is stretchable and, when in place, slightly urges arms 22a, 22b inwardly about a typical coffee cup from a coffee shop. Arms 22a, 22b are preferably widest (e.g., 1-2″ wide) at their rearward junction proximate clamp 24 and taper slightly at their distal ends (e.g., ½-1½″ wide). But, arms of other shapes may be used. The arms and bracket may be made of nylon and may be molded. The bracket 24 is preferably round and has a center axis 23 disposed at a 90° angle relative to the center axis 27 of the holder. Thus, bracket ring 24 accepts a horizontal bicycle handle bar and clamping ring 21 accepts a beverage container disposed vertically therein.

In the example shown, band 30 has an inside friction surface 32. This material can be molded silicon or other stretchable thermoplastic rubber including natural latex or other synthetic rubber materials.

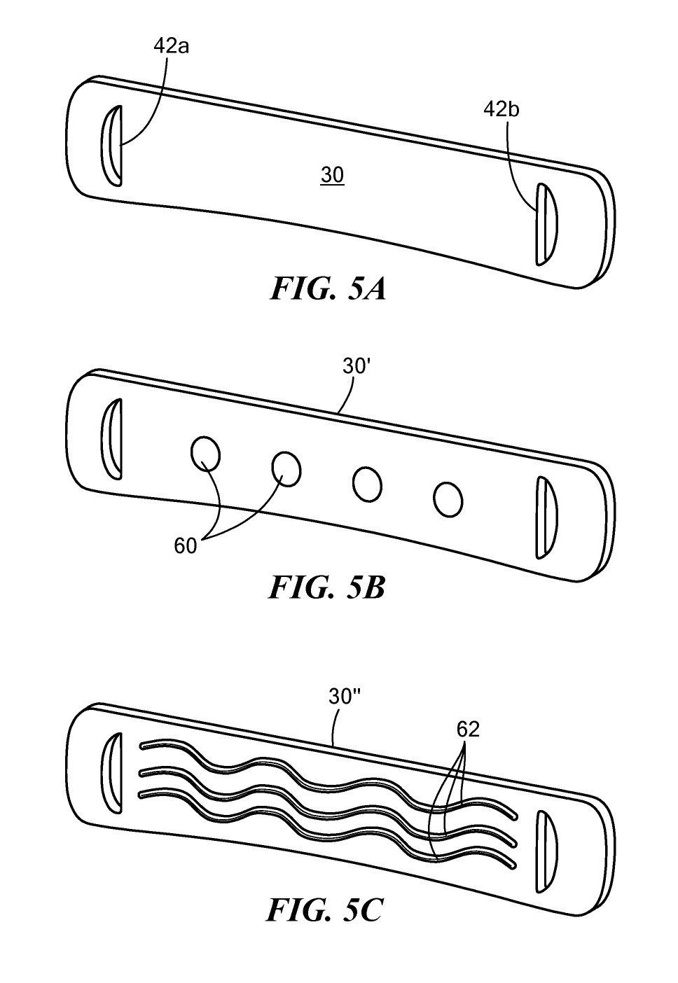

Also, the distal ends 26a, 26b of the arms may each include a hook 40a, 40b and band 30, FIG. 5A may include corresponding end channels 42a, 42b therethrough receiving a corresponding ann hook therein to maintain the band stretched across the holder gap. Other means for so maintaining the position of the band across the arms may be used.

Other inside friction surfaces for band 30 includes raised bumps 60, FIG. 5B, ridges 62, FIG. 5C and the like. Each arm 22a, 22b may further include top and bottom strengthening rings 70a, 70b as shown.

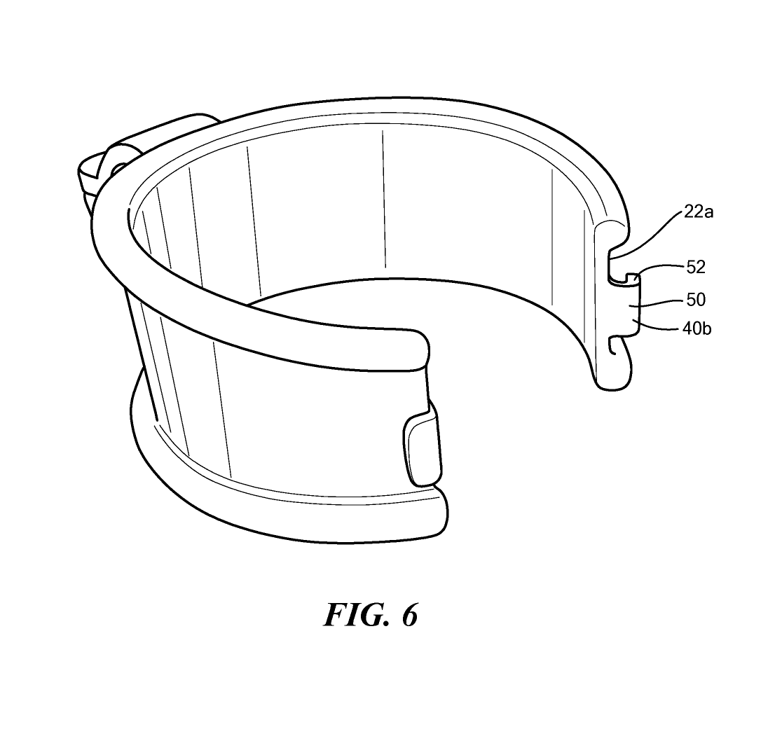

One preferred hook 40b, FIG. 6 includes a section 50 extending outwardly and a rearwardly extending post section 52. The band then securely resides over the section 50 in the space between the post section and the arm.

Materials for the arms include injection molded plastics or other semi-rigid bendable substances. Materials for the stretchable band may include molded silicon or other stretchable thermoplastic rubber including natural latex or other synthetic rubber materials. The holder, except for the band, may be molded.

In this way, the spaced concave arms are biased about a beverage cup via a stretchable band that itself may include an inside friction surface for more securely holding the coffee cup.

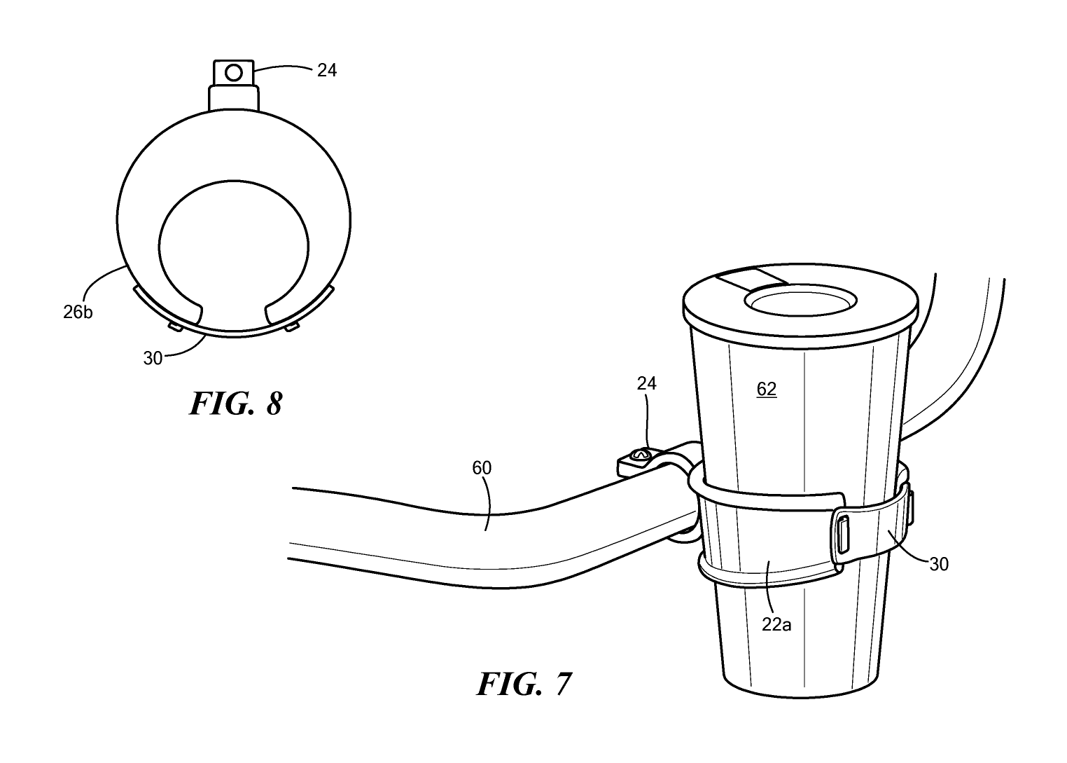

In use, the beverage cup holder including spaced concave arms is clamped to a bicycle handle bar 60 as shown in FIG. 7 using the split ring bracket and a fastener. The bracket is thus oriented to accept a horizontal bar therethough. A beverage cup 62 is inserted downwardly between the arms 22 slightly spreading apart the arms. Thus, the flexible clamp ring is oriented to accept a beverage cup disposed vertically therein. A band 30 is then stretched from the distal end of one arm about the beverage cup and releasably secured to the distal end of the other arm biasing the arms about the beverage cup 62. Thus, the beverage holder expands to accommodate and grip many different size cups as shown in FIG. 8. The holder may also be used with strollers and the like.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A beverage cup holder comprising:
a flexible clamp ring oriented to accept a beverage cup disposed vertically therein, the flexible clamp ring including a rearward wall and concave arms each having a distal end;
a gap between the distal ends of the arms;
a stretchable band disposed across the gap and attached to the distal ends of the arms to bias the flexible clamp ring concave arms about the beverage cup;
a bracket ring extending rearwardly from the flexible clamp ring rearward wall and oriented to accept a horizontal bar therethough.

2. The holder of claim 1 in which at least one said arm distal end includes a hook and the stretchable band includes an end with a channel receiving said hook therein.

3. The holder of claim 2 in which said hook extends outwardly from said arm distal end and includes a rearwardly extending post.

4. The holder of claim 2 in which said arm distal ends each include a hook and the stretchable band includes opposing ends each with a channel receiving a said hook therein.

5. The holder of claim 1 in which the inside of said band includes a friction surface.

6. The holder of claim 1 in which said band is made of rubber.

7. The holder of claim 1 in which said spaced arms each have top and bottom rings.

8. A beverage cup holder comprising:
spaced flexible concave arms each having a distal end;
a gap between the distal ends of the arms;
a bracket for securing the spaced concave arms to a handlebar; and
a stretchable band operatively disposed across the gap.

9. The holder of claim 8 in which at least one said arm distal end includes a hook and the stretchable band includes an end with a channel receiving said hook therein.

10. The holder of claim 9 in which said hook extends outwardly from said arm distal end and includes a rearwardly extending post.

11. The holder of claim 9 in which said arm distal ends each include a hook and the stretchable band includes opposing ends each with a channel receiving a said hook therein.

12. The holder of claim 8 in which the inside of said band includes a friction surface.

13. The holder of claim 8 in which said band is made of rubber.

14. The holder of claim 8 in which said spaced arms each have top and bottom rings.

15. The holder of claim 8 in which the flexible concave arms are oriented to accept a beverage cup disposed vertically between the arms and the bracket is oriented to accept a horizontal handlebar therethough.

16. A method of transporting a beverage cup, the method comprising:
clamping a beverage cup holder including spaced flexible concave arms to a handlebar;
inserting a beverage cup between said arms spreading apart said arms; and
stretching a band from the distal end of one arm about the beverage cup and releasably securing the band to the distal end of the other arm biasing said arms about the beverage cup.

17. The method of claim 16 in which at least one said arm distal end includes a hook and the stretchable band includes an end with a channel receiving said hook therein.

18. The method of claim 17 in which said hook extends outwardly from said arm distal end and includes a rearwardly extending post.

19. The method of claim 17 in which said arm distal ends each include a hook and the stretchable band includes opposing ends each with a channel receiving a said hook therein.

20. The method of claim 16 in which the inside of said band includes a friction surface.

21. The method of claim 16 in which said band is made of rubber.

22. The method of claim 16 in which said spaced arms each have top and bottom rings.
